(19) United States
(12) Patent Application Publication
(10) Pub. No.: US 2010/0189357 A1
(43) Pub. Date: Jul. 29, 2010

(54) METHOD AND DEVICE FOR THE VIRTUAL SIMULATION OF A SEQUENCE OF VIDEO IMAGES

(76) Inventors: Jean-Marc Robin, Vichy (FR); Christophe Blanc, Saint Agoulin (FR)

Correspondence Address: OSLER, HOSKIN & HARCOURT LLP (OTHER), 1000 DE LA GAUCHETIERE STREET WEST, SUITE 2100, MONTREAL, QC, H3B-4W5, CA

(21) Appl. No.: 12/447,197

(22) PCT Filed: Oct. 23, 2007
(86) PCT No.: PCT/FR2007/052234

§ 371 Date: Jan. 6, 2010

(30) Foreign Application Priority Data
Oct. 24, 2006 (FR) 0654483

(51) Int. Cl. G06K 9/46

(52) U.S. Cl. 382/195

(57) ABSTRACT

The invention relates to a method for the virtual simulation of a sequence of video images from a sequence of video images of a moving face/head, comprising: an acquisition and initialization phase of a face/head image of the real video sequence; an evolution phase for determining specific parametric models from characteristic points extracted from said image and used as initial priming points, and for deforming said specific models for adaptation to the outlines of the features of the analyzed face, and also for detecting and analyzing the cutaneous structure of one or more regions of the face/head; and a tracking and transformation phase for modifying the characteristic features of other images in the video sequence and the colors of the cutaneous structure, said modifications being carried out according to predetermined criteria stored in at least one database and/or according to decision criteria of at least one expert system of a 0+ or 1 order.

### CROSS-REFERENCES

The present application is a national stage entry of International Application Number PCT/FR2007/052234, filed Oct. 23, 2007 which claims priority to French Patent Application No. 06 54483, filed Oct. 24, 2006, the entirety of both of which is incorporated herein by reference.

### FIELD OF THE INVENTION

The present invention concerns a method and a device enabling one or several esthetic images of a real objective, for example the face and/or the head of a person moving in a scene, to be simulated and processed automatically and in real time by detecting and following its characteristic features.

### BACKGROUND OF THE INVENTION

The features of the face participate in the communicative act between human beings. However, it must be noted that visualizing the face's characteristic features will support communication only if these features are extracted with sufficient precision. In the opposite case, the information yielded by too raw an analysis will constitute more of a hindrance than a help, notably for high-level industrial applications for the esthetic enhancement of a face/head for example.

It is known that there are in the beauty industry a certain number of equipments for visualizing virtually an esthetic self-image, for example applying a digital make-up, a hair coloration, a hair style in the form of a hair-piece, and whose employed method remains a supervised and therefore non-automated version that relies on computerized tools for setting points as close as possible to the outlines. A Bézier curve or polynomial parametric curve connects these points to one another. A toolbox then allows the sought transformations to be applied manually, their control being effected manually by an operator and/or the user himself/herself.

For a larger-scale process, a user online on the Internet can, from his own PC or Mac, use with a delay of more than 24 hours and after having posted on the internet his color photograph portrait in JPEG format, and with a certain number of constraints, the services of a web server OS as application service provider (ASP) that performs for the users of a third-party web site the functions of outlining the contours, detecting the hair color, skin tone and eyes, which are obtained using statistic and manual methods performed through the intervention of human technical teams.

The photograph can also be touched up with different overlay techniques. Thus, each element can be placed on a different overlay, the final result being achieved by superimposing all the overlays, which makes it possible to obtain the final touched-up photograph that can be used. The work can be decomposed in this way, which makes easier the task to be performed by the user. The touched-up photograph can then be used locally in a dedicated application, such as active X Microsoft®. This technology and the set of tools developed by Microsoft® enable the programming of components that can make the contents of a web page interact with applications executable on the cybersurfer's PC-type computer, notably with the Windows® operating system. Another equivalent technique consists in using the Java® application.

These applications are called “Virtual Makeover” for local use on PC or MAC and “Virtual Makeover Online” for the Internet. The advantage of this type of systems is to make it possible to achieve esthetic images without explicit manipulation of professional computerized software such as Adobe Photoshop® or Paintshop Pro® or any other type of computer-assisted touching-up, processing and drawing software. They are mainly used for processing digital photographs but also serve for the creation of images ex nihilo.

More recently, equipment has been developed that uses automated image-processing techniques that make it possible, from digitized images, to produce other digital images or to extract information from them, which improves use locally. However, the encoding quality associated to the segmentation of the characteristic features of the face requires standardized photography parameters of the booth type in order to improve the processing robustness from a static color image in the formats JPEG (Joint Photographic Experts Group) and BMP (Bitmap). The simulation remains supervised and is performed sequentially with a processing time varying from 5 to 10 minutes to obtain a two-dimensional esthetic image and up to about 60 minutes for a three-dimensional image, for example the simulation of a make-up.

Document WO01/75796 describes a system allowing a fixed image, such as a photograph of a face, to be transformed virtually.

However, all these methods and devices enumerated here above remain unpractical because they lack instantaneity and because their precision is too random, due to their poor robustness compared with the various constraints as to the subject's posing and to the various environmental conditions of the physical and/or artificial world. Furthermore, the techniques are currently not able to propose robust and good-quality methods for analyzing and transforming the face in real time, let alone in the case of the face/head of a person moving in a scene that can a priori be of any kind.

Robustness vis-à-vis the large diversity of individuals and of acquisition conditions, notably the different presentations in a person's posing, the materials, the uncertain lighting conditions, the different fixed or mobile backgrounds etc., is the crucial issue and represents a certain number of technological and scientific stumbling blocks that need to be overcome to consider large-scale industrialization of such methods in the form of professional or domestic devices.

### SUMMARY OF THE INVENTION

The aim of the present invention is to propose a method and a device for processing images that do not recreate the drawbacks of the prior art.

The aim of the present invention is notably to propose such a method and device for processing video image sequences, in particular for moving subjects.

A further aim of the present invention is also to propose such a method and device that should be simple, reliable and cost-effective to implement and to use.

The present invention thus concerns a method and a highly efficient digital device enabling an automatic and accurate extraction, in a video flux composed of a succession of images, for example 25 to 30 images per second, producing the illusion of movement, of the outlines of all the characteristic features of the face, hair, eye color, skin tone and hair color, and taking into account certain occlusions, to be achieved by computerized means and in real time. All of it leads to making an esthetic and individualized virtual simulation of an initial objective, for example the face/head of a person moving in a scene, in a video flux through a robust and real-time or delayed or play-back processing. This simulation can include an encoding and then a transformation by reading the sequence again.

The present invention thus concerns an automatic method for the virtual simulation of a sequence of video images individually for each user, which can be achieved from a real video image sequence of a moving face/head, comprising during an acquisition and initialization phase: detecting and analyzing the shapes and/or outlines and/or dynamic components of an image of the face/head in the real video sequence, extracting characteristic points of the face/head such as the corners of the eyes and of the mouth, by means of predefined parametric models; during an evolution phase: defining specific parametric models from said extracted characteristic points, which serve as initial priming points, deforming said specific models to adapt to the contours of the features present on the analyzed face, detecting and analyzing the cutaneous structure of one or several regions of the face/head; and during a tracking and transformation phase: modifying the characteristic features of the other images in the video sequence, modifying the colors of the cutaneous structure, said modifications being carried out according to criteria stored in at least one database and/or according to decision criteria of at least one expert system of a 0+ or 1 order.

Advantageously, the detection and analysis phase for determining the region/outline spatial and the temporal information is carried out by maximizing the gradient flows of luminance and/or chrominance.

Advantageously, said modifications are achieved by translating the neighborhoods of the characteristic points of the preceding image into the next image, wherein affine models, including a deformation matrix, can be used when the neighborhoods of the characteristic features can also undergo a deformation.

Advantageously, the tracking phase uses an algorithm for tracking the characteristic points from one image to the other.

Advantageously, said algorithm uses only the neighborhoods of characteristic features.

Advantageously, in order to avoid the accumulation of tracking errors, the characteristic features are readjusted by using a simplified version of the active outlines and/or by deforming the curves of a model obtained at the previous image.

Advantageously, the method comprises a step of modeling the closed and/or open mouth by means of a plurality of characteristic points connected by a plurality of cubic curves.

The present invention also concerns a device for implementing the method described here above, comprising a computer system, a light source, a system for managing electronic messages, at least one database, local or deported onto digital networks such as internet, and/or at least one expert system of a 0+ or 1 order, allowing obtaining and transforming a real digital image sequence into a virtual image sequence, preferably at a speed of 25 images per second, said virtual image sequence being transformed according to decision criteria of at least one expert system of a 0+ or 1 order.

Advantageously, said computer system is based on a single-core, dual-core, quad-core or greater microprocessor of the type CPU (central processing unit), or classic multi-core processors, of the type Pentium, Athlon or greater, or of the type SPU (streaming processor unit), equipped with a main core and up to eight specific cores, placed in a booth, a console, a self-service apparatus, a pocket or mobile device, a digital television, a local server, or deported onto digital networks such as Internet, at least one digital video camera, at least one screen, at least one printer and/or a connection to digital networks, such as Internet, wherein the computer system performing the image processing comprises a computer provided with a hard drive, preferably of a capacity equal to at least 500 kilobytes, and/or with a digital storage memory, one or several supports, notably of the type CD-ROM, DVD, Multimedia Card®, Memory Stick®, MicroDrive®, XD Card®, SmartMedia®, SD Card®, CompactFlash® type 1 and 2, USB key, with a modem or a fixed-line or radio frequency connection module to digital networks, such as Internet, and with one or several connection modules for local networks of the type Ethernet, Bluetooth®, infrared, Wifi®, Wimax® and similar.

Advantageously, after displaying the virtual image sequence on a screen, a printer proceeds locally or remotely to the printing, preferably in color, of at least one photograph chosen from among all or part of the virtual image sequence.

Advantageously, the image-processing module, in order to perform the acquisition, detection, transformation and tracking steps, is integrated into one or several processors specialized in signal processing of the type DSP (digital signal processor).

The present invention thus concerns a method and a device allowing the simulation, by an automatic processing and in all environmental and the moving subject's posing conditions, one esthetic image or a sequence of esthetic images in a video flux, from one or several images of a real objective, for example the face/head of a person moving in a scene, wherein the contours of the dynamic components of the face/head of the moving person are extracted from the real image and/or sequence of images, captured preferably by a digital color video camera, at real time rate, in order to produce relevant parameters for synchronizing the virtual esthetic transformation tools, for example in the area of the eyes, of the eyebrows, of the mouth and neighborhoods, according to multiple criteria provided in at least one database, local and/or deported onto digital networks, such as Internet, and/or according to decision criteria previously defined in the knowledge-based system of at least one expert system of a 0+ or 1 order.

The used computer system can be installed in a booth or a console or a self-service apparatus or a pocket or mobile device or a digital television or a local server or a server deported onto digital networks, such as Internet, or all forms of possible apparatus to come.

In its first destination, it can comprise a computer or a single-core, dual-core, quad-core or greater microprocessor for processing of the type CPU (central processing unit), or classic multi-core processors, of the type Pentium, Athlon or greater, or of the type SPU (streaming processor unit), equipped with a main core and up to eight specific cores or more, having a hard of at least 500 kilobytes and/or a digital storage memory, one or several supports of the type CD-ROM, DVD, Multimedia Card®, Memory Stick®, MicroDrive®, XD Card®, SmartMedia®, SD Card®, CompactFlash® type 1 and 2, USB key or others, all types of modems or fixed-line or radio frequency connection modules to digital networks, such as Internet, one or several connection modules for local networks of the type Bluetooth®, infrared, Wifi®, Wimax® and to come, a fixed color video camera or digital television of the type mono CCD (charge-coupled device) and greater, a light source, discrete or not, all types of screens, preferably color, current and to come, all kinds of monochrome or color printers, current and to come, one or several databases, local or deported onto digital networks including Internet and, depending on the case, an expert system of a 0+ or 1 order.

In a second destination, if it is desired to install such a simulation system in the retail display space of cosmetic product stores, in a specialized institute or office, so as to be as least cumbersome as possible or even kinetic, it could be desirable to have the simulator, depending on the customer's size and for his/her comfort, move of its own accord to the height of the customer's face. This means it does not have any space requirement on the ground.

In this case, the vision system defined above can be composed of a discrete daylight or white light LED, of a mono CCD or greater camera, of a graphic card, of a flat and tactile color screen and of a printer of the type ticket or A4 and A3 color paper or even larger. The whole can then be totally integrated into an ultra compact light PC panel whose size is given by the dimensions of all types of flat screens, preferably color. Processing is local and all the technical or contents updates such as maintenance can be carried out over a fixed-line or radio frequency connection to digital networks such as Internet.

The system functions by visually servo-controlling the device through its camera, by automatically settling onto the user's face by using a module for detecting and tracking the face/head of a person. From a position that will be called of equilibrium, when the user desires a simulation, the system will immobilize when it will have detected its objective, for example the image of a face/head. Depending on the environmental conditions, the vision system can automatically regulate the lighting and the zoom of the camera in order to have an image size and an image code of the face on the screen of nearly constant optimum quality.

In a third destination, the system for controlling the functions of the method can be a terminal, such as an alphanumeric keyboard, a mouse or all other means. The camera, depending on the terminal, can be connected by all connections or all types of digital networks to an editing system, preferably with exit buses onto color screen and/or paper assembled into a single device next to the user. The processing and computing part can be managed by one or several servers, local or deported onto digital networks including Internet, and equipped with at least one microprocessor, for example 32 or 64 bit single-core, dual-core, quad-core or greater microprocessor of the type CPU (central processing unit), or classic multi-core processors, of the type Pentium, Athlon, or of the type SPU (streaming processor unit), or a main core and up to eight specific cell-type cores, and all types of electronic or magnetic memories.

Whatever the device used, capturing the images in color is advantageously achieved in real time by means of all types of digital video cameras, preferably color, such as a digital color video camera mono or CCD, or a CCD and greater device, a CMOS (complementary metal-oxide semiconductor) digital color video camera, or similar, for example a Webcam, in order to supply in real time an accurate esthetic simulation by high-quality detection of the geometric and dynamic components of the face and by suitable image processing. In order to be sufficiently user-friendly, the processing can be performed locally or on a remote server and, depending on the computing speed, in real time or considered as such, or in read-back mode.

The whole of the processing can be performed without too many constraints as regards lighting or posing for each person present in the image, considering an uncertain fixed or mobile background and a certain number of occlusions.

Thus, in various environmental conditions of the physical and/or artificial world, experiments demonstrate that the method implemented according to the present invention remains robust and sufficiently accurate during the phase of extraction and evolution of the outlines of the permanent features of the face/head, viz. notably: the eyes, the eyebrows, the lips, the hair and the other morphologic elements, depending on the sought esthetic transformation, etc.

For each of the considered features, a smiling or talking mouth for instance, various specific parametric models capable of providing all possible deformations can be predefined and implemented according to the decision criteria of the database expert system.

The method advantageously comprises three synchronized phases:
1. An acquisition and initialization phase: the shapes and/or contours of the face/head in a digital video sequence corresponding to the first image of a sequence are analyzed and detected. The characteristic points and interest areas of the face/head are extracted, the corners of the eyes and of the mouth for example, and serve as initial priming points for each of the adapted predefined parametric models. In the evolution phase, each model is deformed in order to best coincide with the outlines of the features present on the analyzed face. This deformation is done by maximizing the gradient flow of luminance and/or chrominance along the outlines defined by each curve of the model. The definition of models allows a regularizing constraint to be introduced naturally on the desired outlines. However, the chosen models remain sufficiently flexible to allow a realist extraction of the eye, eyebrow and mouth contours.
2. A tracking and transformation phase: the tracking allows the segmentation to be performed in a more robust and faster way in the subsequent images of the video sequence. The transformation leads to the modification of the characteristic fine zones of the face/head followed in the video sequence according to multiple criteria provided in the database and/or, depending on the case, according to decision criteria of at least one expert system of a 0+ or 1 order.
3. A restitution phase offering on a screen and/or on paper and/or through a server on all digital networks the results of the transformation phase for the entire video sequence.

During the first phase, the video sequence processing system will coordinate several successive operations.

At first, it proceeds on the first image of the sequence to localizing the face/head of the person moving in a scene by considering the typical chrominance information associated with skin. The detected face/head corresponds to an interest zone in the image.

Following this extraction, the method allows eliminating the lighting variations by using a filtering adapted to the behavior of the retina, for the interest zone.

The system then proceeds, for the thus filtered interest zone, to the extraction of the face's characteristic features, preferably with the aid of adapted parametric models, namely the irises, eyes, eyebrows, lips, face contour and crown of hair.

For the iris, the semi-circle that maximizes the normalized gradient flows of luminance in each right and left quarter of the rectangle encompassing the face will be looked for.

The initial positioning of each model onto the image to be processed takes place after the automatic extraction of characteristic points of the face.

A process of tracking the gradient points of maximum luminance can be used to detect the corner of the eyes. Two Bézier curves, including an improved one that bends towards its extremity to follow naturally the shape of the eye's lower contour, being the models chosen for the upper and lower eye contours, can be initialized by the two corners of the eyes and the lowest point of the circle detected for the iris for the lower contour, and by the two corners of the eyes and the center of the circle detected for the iris for the upper contour.

To initialize the Bézier curve associated to the eyebrows, the two inside and outside corners of each eyebrow can be extracted.

The model proposed for modeling the lips is advantageously at least composed of five independent curves, each of which following naturally part of the external labial contour and at least two curves for the inside contours. The characteristic points of the mouth for initializing the model can be analyzed by jointly using discriminating information combining the luminance and the chrominance as well as the convergence of a type of active outline allowing avoiding adjusting the outline parameters as well as its high dependency on the initial position.

Modeling the face outline advantageously uses eight characteristic points situated on this outline. These eight points initialize an outline modeled by deformable ellipse quarters according to the position of the face in a temporal dimension.

The crown of hair can be segmented from the detection of the face outline by associating the image background filtering to use of active outlines. Characteristic points situated on the hair outline are thus detected. Between each of these points, the used model can be a cubic polynomial curve.

All the proposed initial models can then be deformed so that each sought outline is a set of maximum luminance gradient points. The selected curves will preferably be those that maximize the normalized gradient flow of luminance throughout the outline.

During the second phase, the tracking step allows the segmentation in the following images of the video sequence to be performed. During this step, the results obtained in the preceding images supply additional information capable of making the segmentation more robust and faster. The accurate tracking procedure, according to an advantageous embodiment of the present invention, uses an algorithm that allows the characteristic points to be followed from one image to another. This differential method, using only the neighborhood of points, affords a significant gain of time by comparison to a direct extraction technique. In order to avoid the accumulation of tracking errors, the characteristic features are readjusted by using a simplified version of the active outlines and/or by deforming the curves of a model obtained at the previous image.

The transformation step can lead to the modification of characteristic fine zones of the face/head followed in the video sequence according to multiple criteria provided in the database(s) and/or, depending on the case, according to decision criteria of at least one expert system of a 0+ or 1 order. The present invention can suggest to the user different looks, palettes, present in the database for being visualized on his/her face. In order to propose a precise and realist esthetic simulation depending on the processed face, the system can, on the basis of anthropometric ratios performed by an expert system of a 0+ or 1 order, look for the characteristic zones, for example the cheekbones, to be transformed. Furthermore, for each face, the expert system can define the make-up procedures that depend on the shape of the face, round or elongated or square or triangular or oval, and on certain characteristics, eyes wide apart or close together or equal, size of the nose etc. These rules can be communicated to the transformation module for a simulation that is realist and dependent on each face to be transformed. The method, during this phase, also classifies the faces such as man, woman, child, adolescent notably.

Finally, the restitution phase offers on a screen and/or on paper and/or through a server on all digital networks the results of the transformation phase for the entire video sequence and/or for part of this sequence.

### BRIEF DESCRIPTION OF THE DRAWINGS

Other aspects and advantages of the present invention will appear in the course of the following detailed description, made with reference to the attached drawings given by way of non limiting example, wherein:

FIG. 1 is a block diagram of a virtual image simulation system according to an advantageous embodiment of the present invention;

FIG. 2 is a block diagram illustrating the extraction phase of the faces/heads of persons and the characteristic zones according to an advantageous embodiment of the present invention;

FIG. 3 represents the block diagram of retinal filtering;

FIG. 4 is a drawing of one of the parametric models adapted for following moving lips;

FIG. 5 represents the result of the automatic extraction of the characteristic zones of the face from a video sequence presenting a single person with a head moving in front of the camera's objective along the orientation axes X, Y and Z symbolized on this same figure, namely the contour of the face, the irises, the eyes, the mouth, the eyebrows and the crown of hair;

FIG. 6 represents the result of an esthetic simulation such as a look, before and after the transformation.

### DETAILED DESCRIPTION

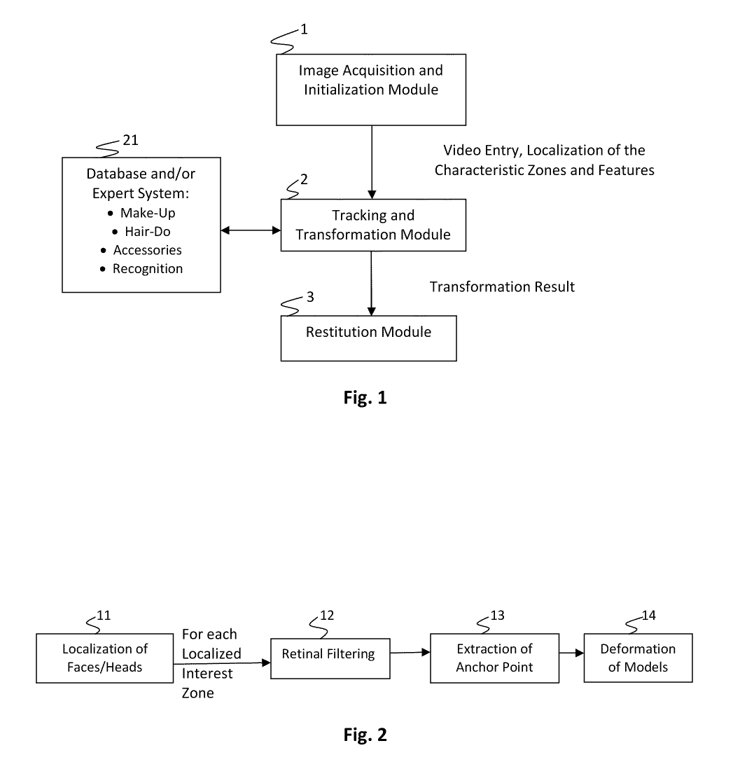

FIG. 1 represents an example of automatic detection and tracking system in real time of the characteristic features of a real objective, such as the face/head of a person moving in a scene, with the possibility of virtual image simulation and comprising an image acquisition and initialization module 1, a tracking and transformation module 2 and a restitution module 3. Each module will be described in more detail hereafter.

The image acquisition and initialization module 1 is implemented from all types of digital color video cameras, such as a digital color video camera mono or CCD, or a CCD and greater device, a CMOS (complementary metal-oxide semiconductor) digital color video camera, or similar.

The sequence of images taken by the acquisition module is analyzed in order to detect the characteristic zones and points of the face/head. This analysis is executed in the form of a 32 or 64 bit single-core, dual-core, quad-core or greater microprocessor of the type CPU, SPU or a main core and up to eight specific cell-type cores or classic multi-core processors of the type Pentium, Athlon, or a personal computer or of a digital signal processing processor. The characteristic zones and points of the face/head of the person moving in a scene thus extracted and coupled to the flux of images are sent to the tracking and transformation module which, according to multiple criteria provided in one or several database(s) and/or, depending on the case, according to decision criteria of one or several expert system(s) 21, returns to the restitution module 3 its results: a video sequence with, for example, the made-up face. The restitution module offers, according to the present invention, the results on any type of screen (cathode, LCD, plasma or the like) and/or on any format of paper and/or through a server on all digital networks, for example Internet.

FIG. 2 represents a block diagram illustrating the extraction phase of the person's face/head and of the characteristic zones according to the present invention.

Regarding the initialization module 1, the video sequence processing software, working at the acquisition speed of the digital video sensor, will coordinate several successive operations according to the invention.

In a first step, it will proceed with the localization 11 of the face/head of the person in a scene. To this end, one considers the typical chrominance information associated with skin. The interest zone of the image is thus delimited by an encompassing rectangle. A pre-processing phase 12 of this interest zone enables avoiding lighting variations by using an adapted filtering inspired by the behavior of the retina. This filtering allows, by performing a succession of adaptive filterings and compressions, a local smoothing of the lighting variations to be achieved. Let G be a Gaussian filter of size 15×15 and of standard deviation σ=2. Let Iin be the initial image and I1 the result of its filtering by G. From the image I1, the image X0 can be defined by the relation:

$${X}_{0} = \frac{0.1 + 410 {I}_{1}}{105.5 + {I}_{1}}$$

The image X₀ enables the compression function C to be defined by the relation:

$$C \text{:} I \to \frac{( 255 + {X}_{0} ) I}{{X}_{0} + I}$$

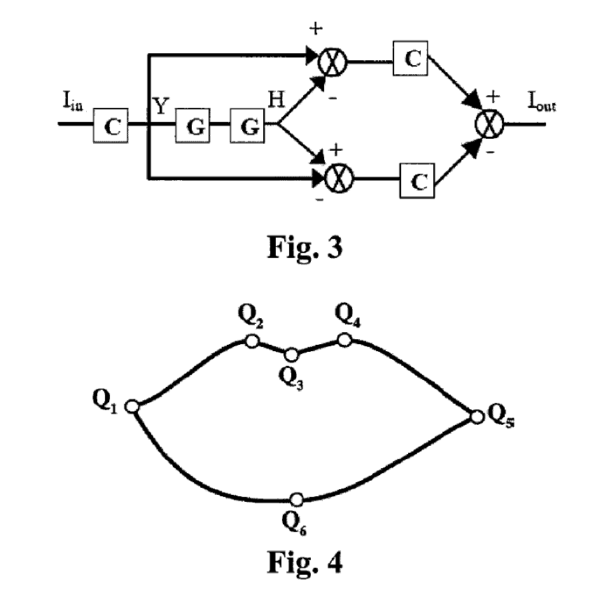

FIG. 3 gives the block diagram of the retinal filtering, the output of this filtering is noted Iₒᵤₜ. For example, at the end of the filtering, on a face lit laterally that presents because of this a considerable variation in luminance between the left and the right sides of the face, the variations in luminance will be strongly reduced.

The automatic extraction of the outlines of the face's permanent features, namely the face outline, whose homogeneity is taken into account, the irises, the eyes, the eyebrows, the lips, the crown of hair, follows in a second step. For each of the considered features, a specific parametric model (cubic polynomial curves, Bézier curves, circle etc.) capable of providing all the possible deformations is defined.

For the iris, the semi-circle that maximizes the normalized gradient flow of luminance in each right and left quarter of the rectangle encompassing the face will be looked for since the outline of the iris is the border between a dark zone, the iris, and a light zone, the white of the eye. The method of maximizing the normalized gradient flow of luminance has the advantage of being very quick, without parameter adjustment, and it leads without ambiguity to the selection of the correct semi-circle since the normalized gradient flow always has a very marked peak corresponding to the correct position for the sought semi-circle.

Characteristic points of the face are extracted (corners of the eyes and of the mouth for example) and serve as initial anchor points for each of the 13 other models.

The Bézier curves, including one that bends towards its extremity, being the models chosen for the upper and lower eye contours, are initialized by the two corners of the eyes, detected by a tracking process of maximum luminance gradient points, and the lowest point of the circle detected for the iris for the lower contour, and by the two corners of the eyes and the center of the circle detected for the iris for the upper contour.

To initialize the Bézier curves associated to the eyebrows, the two inside and outside corners of each eyebrow are advantageously extracted. For each eyebrow, the searching zone of these points is reduced to the zone of the image situated above the detected iris. For computing the abscissae (X-coordinates) of the inside and outside corners, one looks for the abscissae of the points for which there is a change of sign or where the differential coefficient of the horizontal projection of the image valley along the lines is cancelled. To compute the ordinates (Y-coordinates) of these points, one looks for the abscissa of the maximum of the vertical projection of the image valley along the columns. The two inside and outside corners and the center of the two corners serve as initial control points for the Bézier curve associated with each eyebrow. This method being subjected to noise, the points thus detected are readjusted during the deformation phase of the model associated with the eyebrows.

The model proposed for modeling the lips can be composed of five independent cubic curves, each of which following part of the external labial contour. FIG. 4 represents a drawing of this model for a closed mouth. Contrary to most of the models proposed in the prior art, this original model is sufficiently deformable to represent faithfully the specificities of very different lips. Between Q₂ and Q₄, Cupid's bow is described by a pecked line whilst the other portions of the outline are described by cubic polynomial curves. Furthermore, one set the constraints of having a zero differential coefficient at the point Q₂, Q₄ and Q₆. For example, the cubic between Q₁ and Q₂ must have a zero differential coefficient at Q₂. The extraction of the characteristic points Q₁, Q₂, Q₃, Q₄, Q₅, Q₆ of the mouth with the aim of initializing the model is done by jointly using discriminating information combining the luminance and the chrominance as well as the convergence of a type of active outline avoiding adjusting the outline parameters as well as its high dependency on the initial position. The same applies to the inside labial contours where two curves allow the inside contours to be followed perfectly.

Detecting the inside contour is more difficult when the mouth is open, because of the apparently non-linear variations inside the mouth. In fact, during a conversation, the zone situated between the lips can take on different configurations: teeth, mouth cavity, gums and tongue.

The parametric model for the inside contour, when the mouth is open, can be composed of four cubics. For an open mouth, the inside Cupid's bow is less pronounced than for a closed mouth; thus, two cubics are sufficient to extract accurately the upper inside contour of the lips. With four cubics, the model is flexible and allows the problem of the segmentation of the inside contour for asymmetrical mouths to be overcome.

Two active outlines called “jumping snakes” can be used for adjusting the model; the first one for the upper contour and the second for the lower contour.

The convergence of a “jumping snake” is a succession of growing and jumping phases. The “snake” is initialized from a seed, then it grows by adding points to the left and to the right of the seed. Each new point is found by maximizing a gradient flow through the segment formed by the current point to be added and the preceding point. Finally, the seed jumps to a new position closer to the sought outline. The growing and jumping processes are repeated until the jumping amplitude is lower than a certain threshold. The initialization of the two “snakes” beings by looking for two points on the upper and lower contours, and belonging to the vertical going through Q₃ on FIG. 4. The difficulty of the task resides in the fact that there can be different zones between the lips, which can have similar or completely different characteristics (color, texture or luminance) than those of the lips when the mouth is open.

From the detected key points, the final lower contour can be given by four cubics. The two cubics for the upper contour can be computed by the method of the least squares. Similarly, the two cubics of the lower contour can also be computed by the method of the least squares.

Modeling the face outline advantageously uses eight characteristic points situated on this outline a priori since a face can have very long hair that totally cover the forehead and possibly the eyebrows and the eyes: two points at the level of the eyes, two points at the level of the eyebrows, two points at the level of the mouth, one point at the level of the chin and one point at the level of the forehead, which are extracted from a thresholding in the plane V of the HSV (hue, saturation, value) representation of the image. These eight points initialize an outline modeled by ellipse quarters.

The crown of hair can be segmented from the detection of the face outline by associating the image background filtering to use of active outlines. Characteristic points situated on the hair outline are thus detected. Between each of these points, the used model can be a cubic polynomial curve.

It is possible that the automatic extraction of one or several points fails, in which case the point(s) can very easily be replaced manually to replace the model(s) correctly and initiate their evolution phase.

In the evolution phase of the models, each model is deformed 14 in order to best coincide with the outlines of the features present on the analyzed face. This deformation is done by maximizing the gradient flow of luminance and/or chrominance along the outlines defined by each curve of the model.

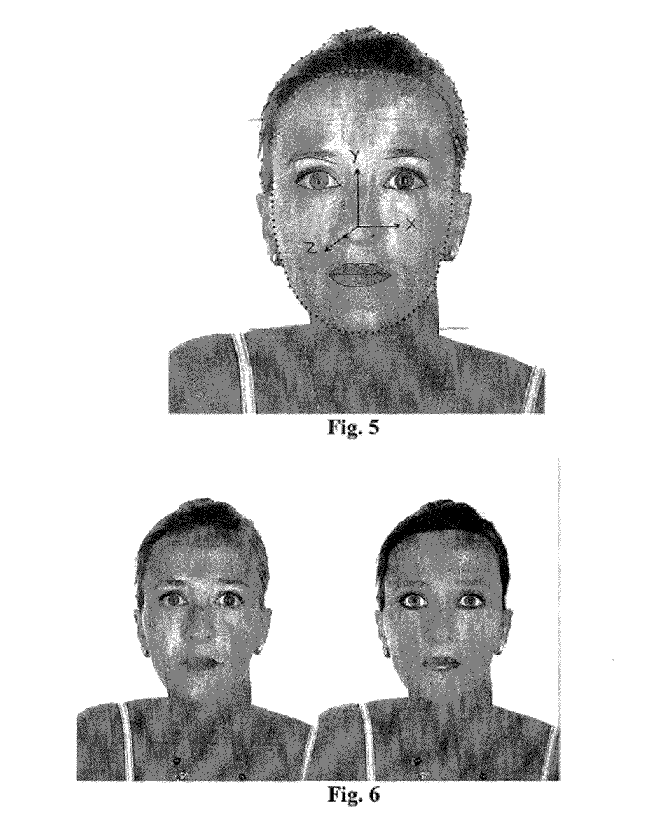

The definition of models allows a regularizing constraint to be introduced naturally on the wanted outlines. However, the chosen models remain sufficiently flexible to allow a realist extraction of the eye, eyebrow and mouth contours. FIG. 5 represents the result of the automatic extraction of the characteristic zones of the face, namely the outline of the face, the iris, the eyes, the mouth, the eyebrows and the crown of hair that form respectively anthropometric modules of the face, according to one aspect of the present invention.

In a third step, the software proceeds with tracking the face/head and the characteristic features of the face in the video sequence. During tracking, the results obtained in the preceding images supply additional information capable of making the segmentation more robust and faster.

The accurate tracking procedure, according to an advantageous embodiment of the present invention, uses an algorithm that allows the characteristic points to be followed from one image to another. This differential method, using only the neighborhood of points, affords a significant gain of time by comparison to a direct extraction technique. This method relies on the apparent movement constrain equation arising from a development by Taylor of the following equation:

Iₜ(x−d(x))=Iₜ₊₁(x)

It is assumed that the neighborhood of the point followed in the image It will be found again in the following image Iₜ₊₁ by translation. d₍ₓ₎ is the displacement vector of the pixel of coordinate x where x is a vector. Let us consider neighborhood R of size nxn in the reference image taken at the time t. The aim is thus to find again in the next image the region that most resembles R. If one notes Iₜ(x) and Iₜ₊₁(x) the values of levels of grey in these two images, the method minimizes the cost function equal to the sum of the differences inter pixels to the square.

Furthermore, in order to avoid the accumulation of tracking errors, which would yield approximate results, the method advantageously uses a readjustment of the characteristic points by using a simplified version of the active outlines and/or by deforming the curves of a model obtained at the previous image. Finally, the final outlines are extracted. For this, the shape of the characteristic zones in the preceding image as well as the characteristic points are used to calculate the optimum curves constituting the different models.

During the transformation phase, the recognition and tracking tools of the anthropometric zones of the face in the image communicate all the data they have extracted during the transformation phase. According to multiple criteria provided in the database and/or, depending on the case, according to decision criteria of an expert system of a 0+ or 1 order, the module will then determine the processing to be done. The latter will be determined by the theme or themes the user will have chosen. Hence, for example, if it is a make-up operation, the characteristic zones of the face, defined according to the extraction results and according to the function chosen by the user (look/palette), will be modified automatically in the sequence of consecutive images depending on harmonic and personalized choices. For example, for a round face, the method tones down the sides of the face in a darker tone. On the contrary, for a triangular face, the method shades off the sides of the face in a lighter tone. The user can chose the look, present in a database, which he/she wishes to apply to the face appearing in the consecutive images. The looks are particular drawings previously defined with the one skilled in the art. These appropriate drawings and forms are characterized as being predefined virtual templates that will be recalculated and readjusted to the zones of the face to which they are applied, according to the information arising from the extraction and tracking module, from the context of the image and the effects they are to suggest.

The user can also choose zone by zone (lips, eyes, cheekbones, face etc.) the color he/she wishes to apply. These colors will be in harmony with the characteristics of the face. Thus, the expert system determines a palette of available colors, correlated with those of a range available in its database(s), according to the data arising from the initialization and evolution phase.

Thus, during the restitution phase, the tool will be able to make a coloring suggestion in harmony with the face, for example, but also suggest a selection of colors, from a range, in perfect harmony with the face. The colors, completed with their original textures, are analyzed, computed and defined in their particular context (the lipsticks or the gloss or the powders notably).

The tools will then apply, depending on the texture of the zone (lip, cheek, hair etc.), the color corresponding to the make-up, but also in transparent fashion the effect of the cosmetic product, i.e. its real aspect will be reproduced, for example its brilliance, its powdered or glittering aspect (glitter lipstick in FIG. 6), notably its mate aspect. This operation takes into account the context of the sequence of consecutive images in each of their respective zones (lighting, luminosity, shades, reflects etc.), which, with the aid of algorithmic tools, allows their textures to be computed, them to be defined in their real aspect, such as they would be reproduced in reality.

With this method, the quality and realistic properties of the sequence of consecutive images will be considerably improved. Furthermore, certain particularities of the face are improved. Thus, for example, forehead lines, crow feet, rings under the eyes, glabellar frown lines, nasolabial folds, marionette lines, peribuccal wrinkles, freckles, acne and broken veins are strongly smoothed over.

Also, esthetic treatments such as whitening of the face, tanning, whitening of the teeth, eyelid lifting, lip augmentation/enhancement, slight rectification of the face oval, rectification of the shape of the chin and/or nose, raising and augmentation of the cheekbones are simulated automatically for a face appearing in a video sequence.

It is also possible to improve the esthetics of the face in relation to a new hair-style and/or hair color. It is also possible to adjust the color, the material, the shape and/or adequate dimensions of spectacle frames, jewelry and/or ornament accessories to the face, or to adjust color or fun contact lenses to suit the iris shade. It is also possible to apply the invention to facial biometric techniques, for example to identify with an optimum reliability rate a known face whose characteristic information is loaded in the database of the expert system. It is also possible to make digital identity photos to the biometric passport norm.

The invention also allows the visemes that describe the different configurations, or different pronounced phones, of a speaking mouth. It thus makes it possible to determine the personality and character of a person, examined from the morphological observation of his/her face/head, such as for example the presence of marionette lines, the size and spacing of the eyes, the size and shape of the nose, of the ear lobes, the database corresponding to the observation of the faces being then completed by the techniques used by morpho-psychologists, psychiatrists, profilers and anatomists in the considered field.

It is also conceivable to apply the invention to digital photography done notably in identity photo or fun photo booths, on automatic development terminals of instant digital photos, on computerized systems for touching up and developing images, enabling the esthetic of the image of a user to be made-up, improved or valorized, the database being then completed with a collection of esthetic rules and make-up looks, usable simultaneously or not, concerning make-up, fun, hair-style, hair techniques, skin texture and accessorizing.

All of the RGB elements or red, green blue completed with the drawing, thresholding and coordinate indications, constituting the creation of a “look” or the natural visualization of a lipstick in a palette for example, can be implemented and recorded in the form of a simple file composed of a low-weight alphanumeric chain that can be diffused on all digital supports or downloaded from a server on the digital networks such as Internet. This file can serve for the artistic update of the database or of the expert system in a flexible and fast manner or can be used immediately by the user through a simple download from a web page for example.

Generally, the database associated to the expert system is enriched of specific rules relative to the application of the invention, for example cosmetics and/or dermatology, plastic surgery and/or esthetic medicine, opthalmology, techniques of stylists and/or hairdressers, facial biometry, etc.

Thus, the processing is independent of the content, which allows the method to be used at industrial scale and its use to be spread very widely with a highly increased performance.

More generally, the characteristic features of the face in the video sequence are modified according to decisions of the database and/or of the expert system. FIG. 6 represents the before/after result of a simulation of make-up (look), of accessorizing (color lenses, piercing) and of hair coloration for an image extracted from a video sequence acquired by a color video camera.

The restitution module, according to the present invention, translates into displaying the sequence of transformed images on any type of color screen and/or subsequently by printing one or several simulated images on any kind of paper format and/or via a server on all digital networks.

For the simulation, the restitution phase translates into an esthetic proposal characterized by the transformation of the initial video sequence into a new virtual video sequence on which the desired esthetic modifications appear in perfect concordance. For example a make-up, completed with accessories and hair coloration, and the references and selling prices of the corresponding products in one or several brands.

A static image chosen by the user from the video sequence can then be edited locally, on a color dot-matrix, ink jet, solid ink jet, laser or dye sublimation transfer printer, in an A4 format or any other technically available format.

The content of this information formulates a beauty prescription, including the initial image and the transformed image, technical and scientific advice, tricks of the trade, face characteristics (shape, color etc.), the picture of the products, the personal color palette in harmony with the characteristics of the transformed face, clothing color advice in relation to the palette etc. The results can in the same way be edited on delocalized high definition printers of an Internet server that will then re-expedite them to the user's postal address.

These same results can be translated, in the same way, on or in different supports, pre-printed or not (CV, virtual postcard, multimedia clip, video, calendar, banner, poster, photo album etc.) available through the server applications. They can be archived in all kinds of memories of the terminal or on the Internet server for later use.

The new image and/or the new video sequence completed or not with the information can be sent by the email function and with the aid of the “attach” command to one or several correspondents having an email-type electronic address. The same goes for a mobile telephone apparatus having MMS mode, email or to come.

It will be easily understood that this system can have very many applications by completing the expert system(s) and/or the local or remote database(s) with specific scientific and technical data.

The invention can find application for image processing in two or three dimensions. In a 3D application, it is possible to build a 3D modeling of the face to apply precisely 3D make-up. The 3D reconstruction of the face, from a static image of the face of a flux of face images, is achieved with the aid of conventional algorithms and procedures, such as the analysis of shadows, texture, movement, use of generic 3D models of faces or further by using a stereoscopic system.

Although the invention has been described with reference to various advantageous embodiments, it is understood that it is not limited by this description and that the one skilled in the art can modify it in any way without leaving the framework of the present invention defined by the attached claims.

1. A method for virtual simulation of a sequence of video images individualized for each user, which can be achieved from a real video image sequence of at least one of a face and a head, the method comprising:
during an acquisition and initialization phase:
detecting and analyzing the at least one of shapes, outlines and dynamic components of an image of the at least one of the face and the head in the real video sequence, and
extracting characteristic points of the at least one of the face and the head, the characteristic points including corners of eyes and mouth, based on predefined parametric models;
during an evolution phase:
defining specific parametric models from the extracted characteristic points, which serve as initial priming points,
deforming the specific parametric models to adapt to contours of features present on the at least one of the face and the head, and
detecting and analyzing cutaneous structure of at least one region of the at least one of the face and the head; and
during a tracking and transformation phase:
modifying characteristic features of other images in the video sequence,
modifying colors of the cutaneous structure,
the modifications being carried out according to at least one of criteria stored in at least one database and decision criteria of at least one expert system of a 0+ or 1 order, and
the tracking phase using an algorithm for tracking the characteristic features from one image to the other, the algorithm using only a neighborhood of characteristic features.

2. The method according to claim 1, wherein detecting and analyzing is carried out by maximizing gradient flows of at least one of luminance and chrominance.

3. The method according to claim 1, wherein the modifications are achieved by translating neighborhoods of the characteristic points of a preceding image into a next image, wherein affine models, including a deformation matrix, can be used when the neighborhoods of the characteristic points can also undergo a deformation.

4. (canceled)

5. (canceled)

6. The method according to claim 1, wherein in order to avoid accumulation of tracking errors, the characteristic points are adjusted by at least one of using a simplified version of active outlines and deforming curves of a model obtained at a previous image.

7. The method according to claim 1, comprising modeling at least one of a closed mouth and an opened mouth with a plurality of characteristic points connected by a plurality of cubic curves.

8. (canceled)

9. (canceled)

10. (canceled)

11. (canceled)

12. A system for virtual simulation of a sequence of video images individualized for each user, which can be achieved from a real video image sequence of at least one of a face and a head, the system being adapted to:
during an acquisition and initialization phase:
detect and analyze at least one of shapes, outlines and dynamic components of an image of the at least one of the face and the head in the real video sequence, and
extract characteristic points of the at least one of the face and the head, the characteristic points including corners of eyes and mouth, based on predefined parametric models;
during an evolution phase:
define specific parametric models from the extracted characteristic points, which serve as initial priming points,
deform the specific parametric models to adapt to contours of features present on the at least one of the face and the head, and
detect and analyze cutaneous structure of at least one region of the at least one of the face and the head; and
during a tracking and transformation phase:
modify characteristic features of other images in the video sequence, and
modify colors of the cutaneous structure,
the modifications being carried out according to at least one of criteria stored in at least one database and decision criteria of at least one expert system of a 0+ or 1 order,
the tracking phase using an algorithm for tracking the characteristic features from one image to the other, the algorithm using only a neighborhood of characteristic features.

13. The system as claimed in claim 12, further comprising:
a computer system;
a light source;
a system for managing electronic messages; and
at least one of at least one database and at least one expert system of 0+ or 1 order,
the at least one database being one of a local database and a database deported onto digital networks,
the at least one expert system of a 0+ or 1 order making it possible to obtain and transform a real digital image sequence into a virtual image sequence, preferably at a speed of 25 images per second, the virtual image sequence being transformed according to decision criteria of the at least one expert system of a 0+ or 1 order.

14. The system as claimed in claim 13, wherein the computer system is based on at least one of a CPU (central processing unit) and a SPU (streaming processor unit).

15. The system as claimed in claim 12, wherein, after displaying the virtual image sequence on a screen, a printer prints at least one photograph chosen from at least a part of the virtual image sequence.

16. The system as claimed in claim 12, further comprising an image processing module to perform the acquisition, detection, transformation and tracking phases, the image processing module being integrated into at least one processor specialized in signal processing of the DSP (digital signal processor) type.

17. A method for virtual simulation of an image individualized for each user, which can be achieved from an image of at least one of a face and a head, the method comprising:
during an acquisition and initialization phase:
detecting and analyzing at least one of shapes, outlines and dynamic components of the at least one of the face and the head, and
extracting characteristic points of the at least one of the face and the head, the characteristic points including corners of eyes and mouth, based on predefined parametric models;
during an evolution phase:
defining specific parametric models from the extracted characteristic points, which serve as initial priming points,
deforming the specific parametric models to adapt to contours of features present on the at least one of the face and the head, and
detecting and analyzing cutaneous structure of at least one region of the at least one of the face and the head; and
during a transformation phase:
modifying colors of the cutaneous structure, and
the modifications being carried out according to at least one of criteria stored in at least one database and decision criteria of at least one expert system of a 0+ or 1 order.

18. A system for virtual simulation of an image individualized for each user, which can be achieved from an image of at least one of a face and a head, the system being adapted to:
during an acquisition and initialization phase:
detect and analyze at least one of shapes, outlines and dynamic components of the at least one of the face and the head, and
extract characteristic points of the at least one of the face and the head, the characteristic points including corners of eyes and mouth, based on predefined parametric models;
during an evolution phase:
define specific parametric models from the extracted characteristic points, which serve as initial priming points,
deform the specific parametric models to adapt to contours of features present on the at least one of the face and the head, and
detect and analyze cutaneous structure of at least one region of the at least one of the face and the head; and
during a transformation phase:
modify colors of the cutaneous structure, and
the modifications being carried out according to at least one of criteria stored in at least one database and decision criteria of at least one expert system of a 0+ or 1 order.
